(19) United States
(12) Patent Application Publication
(10) Pub. No.: US 2020/0137278 A1
(43) Pub. Date: Apr. 30, 2020

(54) FILTER FOR GENERATION OF BLURRED REAL-TIME ENVIRONMENT TEXTURES

(71) Applicant: Bobby Gene Burrough, San Jose, CA (US)

(72) Inventor: Bobby Gene Burrough, San Jose, CA (US)

(21) Appl. No.: 16/173,594

(22) Filed: Oct. 29, 2018

(51) Int. Cl. H04N 5/225; G06T 15/04; H04N 5/232

(52) U.S. Cl. CPC H04N 5/22541; H04N 5/2253; H04N 5/23222; H04N 5/232127; G06T 15/04

(57) ABSTRACT

Filter for generation of blurred real-time environment textures. An apparatus includes a diffusion filter that generates diffused light. An amount of diffusion corresponds to a surface characteristic of a surface of an object to be rendered on a display. The apparatus also includes an image sensor that captures the diffused light as an environment texture for rendering as a reflection of the environment on the surface of the object. An apparatus includes a lens that passes light, and an image sensor that captures the light as an environment texture to be rendered on a surface of an object as a reflection of the environment. The apparatus also includes a controller that selectively adjusts a distance between the lens and the image sensor to defocus the light at the image sensor. The amount of defocus corresponds to the surface characteristic of the surface of the object.

### FIELD

The present invention relates to the design and operation of image processing systems.

### BACKGROUND

Computer graphics systems are a mature and prevalent technology. The rendering of computer graphics is common in desktop and mobile computing, having reached billions of devices in active use. One effect provided in computer graphics systems is the rendering of reflective objects. For example, an object in a three-dimensional (3D) scene may be rendered with a reflective surface that reflects other objects in the 3D scene. Reflections can be rendered on the object by applying an environment texture to the surface of that object. Conventional systems utilize a computation process to generate environment textures. However, such computations are expensive in terms of both energy and performance.

Therefore, it would be desirable to have an efficient way to generate environment textures in computer graphics systems.

### SUMMARY

In various exemplary embodiments, methods and apparatus are provided for generating environment textures in computer graphics systems. In exemplary embodiments, apparatus and methods are disclosed that blur an image of the environment surrounding a device and then capture the blurred image as an environmental texture that can be used to generate an environment reflection. Blurring the image and capturing the blurred image in real-time to generate the environment reflection results in increased system performance, energy efficiency, and/or reduced cost over conventional computation techniques.

In an exemplary embodiment, an apparatus is disclosed that includes a diffusion filter that diffuses light from an environment to generate diffused light. An amount of diffusion provided by the diffusion filter corresponds to a surface characteristic of a surface of an object to be rendered on a display. The apparatus also includes an image sensor that captures the diffused light as an environment texture for rendering as a reflection of the environment on the surface of the object.

In an exemplary embodiment, an apparatus is disclosed that includes a lens that passes light representing an image of an environment, and an image sensor that captures the light as an environment texture to be rendered on a surface of an object as a reflection of the environment. The apparatus also includes a controller that adjusts a distance between the lens and the image sensor to defocus the light at the image sensor, wherein an amount of defocus corresponds to the surface characteristic of the surface of the object.

In an exemplary embodiment, a method is disclosed that includes operations of determining a surface type of a surface of a display object to be rendered on a display, determining a distance associated with the surface type, adjusting at least one of a lens and an image sensor so that they are separated by the distance associated with the surface type, and capturing an environment texture from light rays that pass through the lens and strike the image sensor.

Additional features and benefits of the exemplary embodiments of the present invention will become apparent from the detailed description, figures and claims set forth below.

### BRIEF DESCRIPTION OF THE DRAWINGS

The exemplary embodiments of the present invention will be understood more fully from the detailed description given below and from the accompanying drawings of various embodiments of the invention, which should not be taken to limit the invention to the specific embodiments, but are for explanation and understanding only.

FIG. 1 shows devices comprising exemplary embodiments of a diffusion filter system;

FIG. 2 shows a device that includes an exemplary embodiment of a diffusion filter system;

FIG. 3 shows two exemplary objects that illustrate the relationship between surface characteristics and the degree of reflectivity;

FIG. 4 illustrates how light rays interact with the surface of the exemplary objects shown in FIG. 3 based on their surface reflectivity;

FIG. 5 shows a perspective view and a cross-section view of a conventional lens;

FIG. 6 shows a perspective view and two cross-section views of exemplary embodiments of a diffusion filter;

FIG. 7 shows a conventional lens and illustrates how light rays pass through the conventional lens;

FIG. 8 shows an exemplary embodiment of a diffusion filter and illustrates how light rays pass through the diffusion filter;

FIG. 9 shows an exemplary embodiment of a diffusion filter positioned in front of a lens and an image sensor;

FIG. 10 shows an exemplary embodiment of a diffusion filter positioned between a lens and an image sensor;

FIG. 11A shows an exemplary embodiment of an adjustable diffusion filter that adjusts the distance between a lens and an image sensor;

FIG. 11B shows an exemplary embodiment of a fixed diffusion filter that provides a fixed distance between a lens and an image sensor;

FIG. 12 shows a detailed exemplary embodiment of a reflection processor;

FIG. 13 shows an exemplary embodiment of a method for generating environment textures using a diffusion filter; and

FIG. 14 shows an exemplary embodiment of a method for generating environment textures using an adjustable diffusion filter.

### DETAILED DESCRIPTION

The purpose of the following detailed description is to provide an understanding of one or more embodiments of the present invention. Those of ordinary skill in the art will realize that the following detailed description is illustrative only and is not intended to be in any way limiting. Other embodiments will readily suggest themselves to such skilled persons having the benefit of this disclosure and/or description.

In the interest of clarity, not all of the routine features of the implementations described herein are shown and described. It will, of course, be understood that in the development of any such actual implementation, numerous implementation-specific decisions may be made in order to achieve the developer's specific goals, such as compliance with application and business-related constraints, and that these specific goals will vary from one implementation to another and from one developer to another. Moreover, it will be understood that such a development effort might be complex and time-consuming, but would nevertheless be a routine undertaking of engineering for those of ordinary skill in the art having the benefit of the embodiments of this disclosure.

Various exemplary embodiments illustrated in the drawings may not be drawn to scale. Rather, the dimensions of the various features may be expanded or reduced for clarity. In addition, some of the drawings may be simplified for clarity. Thus, the drawings may not depict all of the components of a given apparatus (e.g., device) or method. The same reference indicators will be used throughout the drawings and the following detailed description to refer to the same or like parts.

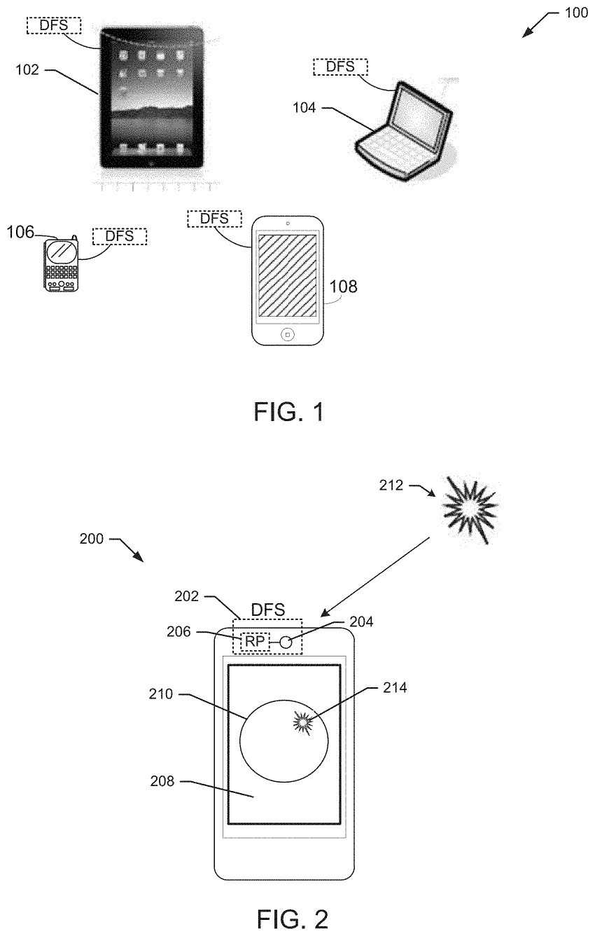

FIG. 1 shows devices 100 comprising exemplary embodiments of a diffusion filter system (DFS). As discussed in greater detail below, the DFS operates to filter environment images as they are captured to increase the speed and efficiency with which environment textures are generated. In exemplary embodiments, the captured environment textures are used to generate environment reflections. The devices shown include tablet computer 102, notebook computer 104, cell phone 106, and smart phone 108. It should be noted that embodiments of the DFS are suitable for use with virtually any type of device that renders reflection data. For example, the DFS also is suitable for use with automobile dashboard systems, billboards, stadium big screens, and virtually all types of devices that perform image processing to render refection data.

FIG. 2 shows a device 200 that includes an exemplary embodiment of a diffusion filter system 202. The DFS 202 includes diffusion filter 204 and reflection processor (RP) 206. The DFS 202 filters environment images as they are captured to increase the speed and efficiency with which environment textures are generated. In an exemplary embodiment, the DFS 202 utilizes a diffusion filter to acquire images that are blurred or out of focus, which correspond to a desired degree of surface reflectivity on a rendered object. By utilizing the diffusion filter, an environment texture can be quickly generated. Conventional techniques perform complex digital computations to generate environment textures, however, the DFS 202 operates to eliminate or reduce the number of computations required.

One aspect of rendering reflections in a 3D graphics pipeline is the degree to which an object is reflective. Objects having a surface that is maximally reflective (e.g., a mirror surface) perfectly reflect their environment. Objects having a surface that is unsmooth or matte have reflections that appear dull, with either very little or no reflection at all. A 3D modeler may choose the degree to which a modeled object is reflective. By applying a diffusion filter to capture an environment texture, the reflection data associated with a particular surface characteristic can be efficiently captured. For example, the device 200 includes display 208 which shows a displayed object 210. The DFS 202 includes the diffusion filter 204 that provides a selected amount of blurring when capturing images. The amount of blurring corresponds to the surface characteristics of the displayed object 210 onto which reflections are to be rendered. For example, the DFS 202 captures the Sun 212 as an environment texture. This environment texture is rendered as a reflection on the surface of the object 210. In an exemplary embodiment, the surface characteristics of the object 210 determine the amount of diffusion filtering provided by the diffusion filter 204. For example, if the surface of the object 210 is a mirror surface, then limited filtering is provided by the diffusion filter 204 such that the reflection 214 of the Sun 212 is sharp and clear as illustrated in FIG. 2. If the surface of the object 210 is a matte surface, then more diffusion filtering is provided by the diffusion filter 204 such that the reflection 214 of the Sun 212 would appear less sharp and less clear.

Thus, the DFS 202 diffuses and captures environment textures where the amount of diffusion is based on the surface of the object onto which reflections are to be rendered. By directly capturing the environment textures, the system provides higher performance, greater efficiency, and reduced cost over computational techniques.

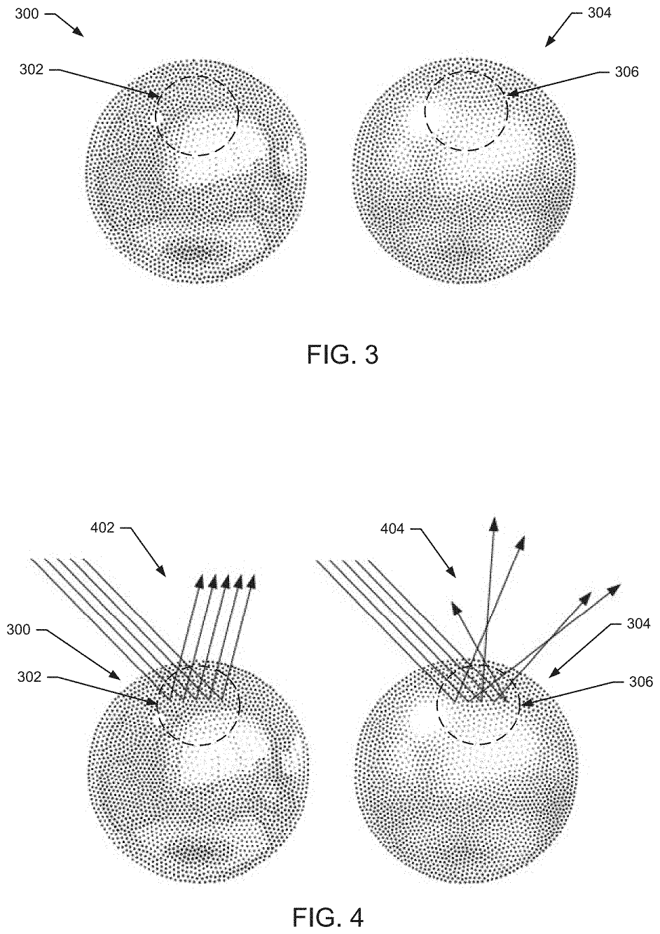

FIG. 3 shows two exemplary objects that illustrate the relationship between surface characteristics and the degree of reflectivity. The reflectivity of each object is demonstrated by elements of the surrounding environment showing on the surface of the object. The first object 300 has a surface characteristic that is highly reflective. Its mirror-like finish is evident due to hard edges and distinct areas of separation of the image reflections as illustrated in the region 302. The second object 304 has a surface characteristic that is only partially reflective. As such, separation of reflected elements is soft and diffuse as illustrated in the region 306. In an exemplary embodiment, the surface characteristics of the object to be rendered determines the amount of diffusion filtering provided by the DFS 202, such that the captured image data provides the appropriate reflection data to be used when the object is rendered with the reflection.

FIG. 4 illustrates how light rays interact with the surface of the exemplary objects shown in FIG. 3 based on their surface reflectivity. The object 300 has a surface that is highly reflective, so light rays 402 are reflected from its surface in a highly ordered manner, as illustrated in the region 302. The object 304 is reflective, but only partially so. As such, light rays 404 are reflected in a somewhat random and/or scattered manner, as illustrated in the region 306. It should be noted that the light rays shown are not to scale, and are not geometrically precise. They simply illustrate that there's a difference between the way a shiny object reflects light, and the way a partially shiny object reflects light. In various exemplary embodiments, the surface characteristics of the object determines the amount of diffusion filtering provided by the DFS 202.

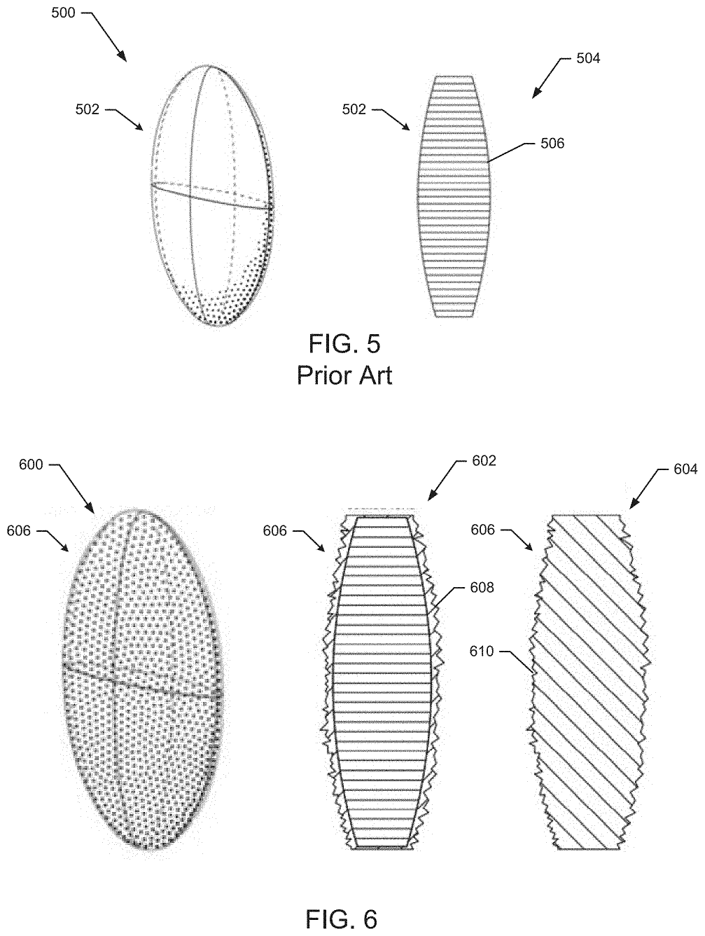

FIG. 5 shows a perspective view 500 and a cross-section view 504 of a conventional lens 502. The lens 502 is a typical optical lens that comprises a smooth surface 506 as shown in the cross-section view 504.

FIG. 6 shows a perspective view 600 and two cross-section views (602 and 604) of exemplary embodiments of a diffusion filter 606. In the perspective view 600, it can be seen that the diffusion filter 606 has been coated with a substance to give it a diffuse, rough or matte surface characteristic. The diffuse surface characteristic will cause light to be diffused as it passes through the diffusion filter 606.

The first cross-section view 602 shows a first exemplary embodiment of the diffusion filter 606 and illustrates a diffusion coating (or surface) 608 that has been placed on a lens. For example, the diffusion filter 606 comprises a matte or diffuse surface using a surface coating. The second cross-section view 604 shows a second exemplary embodiment of the diffusion filter 606 and illustrates how the diffusion filter 606 includes an etched surface 610 that causes light passing through the filter 606 to diffuse.

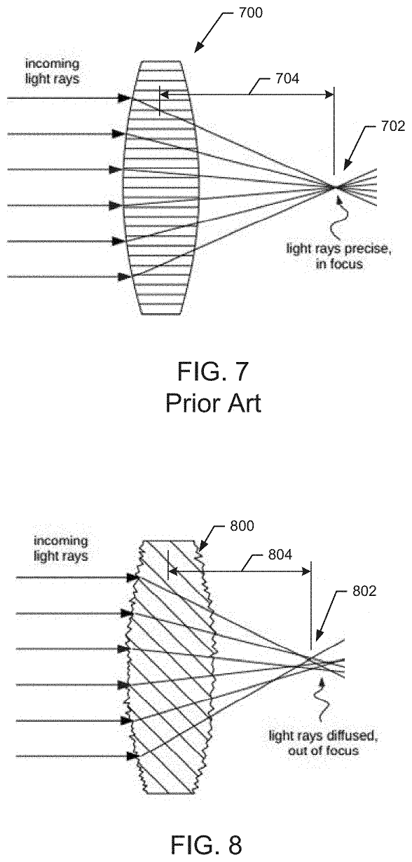

FIG. 7 shows a conventional lens 700 and illustrates how incoming light rays pass through the conventional lens. As illustrated in FIG. 7, the conventional lens 700 passes incoming light rays in a precise, well-ordered manner, such that the resulting images are in focus, as indicated by the sharp and precise focal point 702 located at the focal length distance 704.

FIG. 8 shows an exemplary embodiment of a diffusion filter 800 and illustrates how incoming light rays pass through the diffusion filter. As illustrated in FIG. 8, the diffusion filter 800 passes incoming light rays in a diffuse, scattered manner, such that the resulting images are blurred or out of focus, as indicated by the diffused and blurred focal point 802 that occurs at the focal length distance 804. In an exemplary embodiment, the diffusion filter 800 comprises a lens having an etched surface that diffuses the passing light. In various exemplary embodiments, the lens is made of glass, plastic, or any other suitable material and provides any desired level of dioptric power. In various exemplary embodiments, the lens passes light in at least one of visible, infrared, ultraviolet, microwave, or x-ray spectrums. The lenses also comprise external etched surfaces that have any desire radius of curvature.

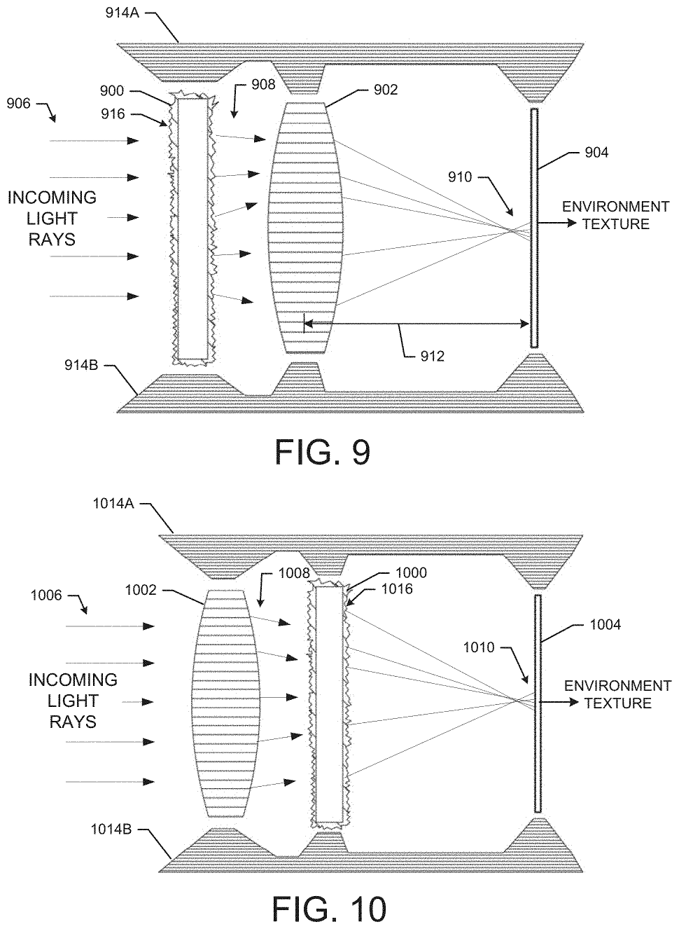

FIG. 9 shows an exemplary embodiment of a diffusion filter 900 positioned in front of a lens 902 and an image sensor 904. In an exemplary embodiment, the diffusion filter 900, lens 902 and image sensor 904 are held into position by mounting apparatus 914A/B.

The diffusion filter 900 includes a coating or etching 916 that operates to diffuse incoming light rays 906 to generate diffused light rays 908. The diffused light rays 908 pass through the lens 902 to form an image (environment texture) that is captured by the image sensor 904. Since the incoming light rays 906 are diffused by the diffusion filter 900, a diffused and blurred image 910 results at the focal distance length 912 of the lens 902.

In an exemplary embodiment, the amount of diffusion provided by the diffusion filter 900 corresponds to particular surface characteristics of an object onto which the environment texture is to be rendered. For example, if the incoming light rays 906 represent environment features to be rendered as a reflection on an object, the amount of diffusion provided by the diffusion filter 900 corresponds to the surface reflectivity of the surface of the object onto which the reflection is to be rendered. Thus, if the object has a smooth mirror-like surface, a minimal amount of diffusion is provided by the diffusion filter 900. However, if the object has a rough or matte surface, more diffusion is provided by diffusion filter 900. The environment texture captured by the image sensor 904 can then be used to render a reflection on the surface of the object.

FIG. 10 shows an exemplary embodiment of a diffusion filter 1000 positioned between a lens 1002 and an image sensor 1004. In an exemplary embodiment, the diffusion filter 1000, lens 1002 and image sensor 1004 are held into position by mounting apparatus 1014A/B. The diffusion filter 1000 scatters or otherwise perturbs the incoming light rays.

In an exemplary embodiment, incoming light rays 1006 pass through the lens 1002 and become focused light rays 1008. The diffusion filter 1000 includes a coating or etching 1016 that operates to diffuse the focused light rays 1008 to generate diffused light rays that form a blurred or diffused image 1010 that is captured by the image sensor 1004. In an exemplary embodiment, the amount of diffusion provided by the diffusion filter 1000 corresponds to particular surface characteristics of a surface of the object onto which image reflections are to be rendered. For example, if the incoming light rays 1006 represent environment features to be rendered as a reflection on an object, the amount of diffusion provided by the diffusion filter 1000 corresponds to the surface reflectivity of the surface of the object onto which the reflection is to be rendered.

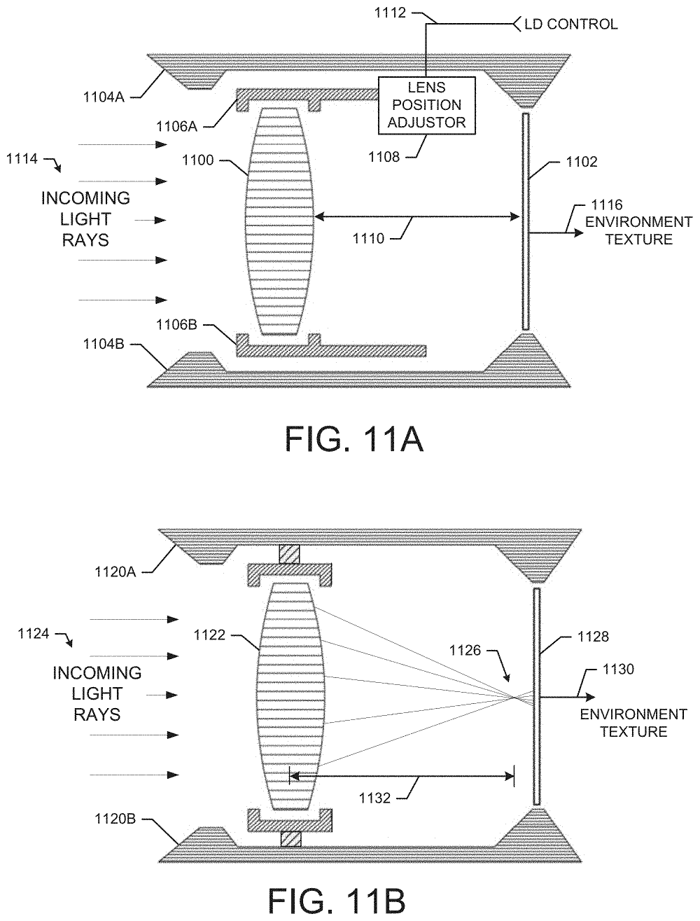

FIG. 11A shows an exemplary embodiment of an adjustable diffusion filter that adjusts the distance between a lens and an image sensor. For example, the adjustable diffusion filter comprises a lens 1100, image sensor 1102, mounting apparatus 1104A/B, sliding rails 1106A/B, and lens position adjustor 1108. In an exemplary embodiment, the lens position adjustor 1108 comprises a motor, actuator or other device that moves the sliding rails 1106A/B along the mounting apparatus 1104A/B in response to a lens distance (LD) control signal 1112.

During operation, incoming light rays 1114 pass through the lens 1100 and are focused on the image sensor 1102. The image sensor 1102 captures and outputs the images as an environment texture 1116. The lens position adjustor 1108 receives the LD control signal 1112, and in response, adjusts the distance 1110 between the lens 1100 and the image sensor 1102. During a first mode of operation, the lens position adjustor 1108 adjusts the position of the lens 1100 so that the images in the incoming light rays 1114 are in focused at the plane of the image sensor 1102. During a second mode of operation, the lens position adjustor 1108 adjusts the position of the lens 1100 so that the images in the incoming light rays 1114 are blurred or out-of-focus at the plane of the image sensor 1102. In an exemplary embodiment, this blurred image is captured as an environment texture by the image sensor 1102 and used to represent surface reflections on a rendered object.

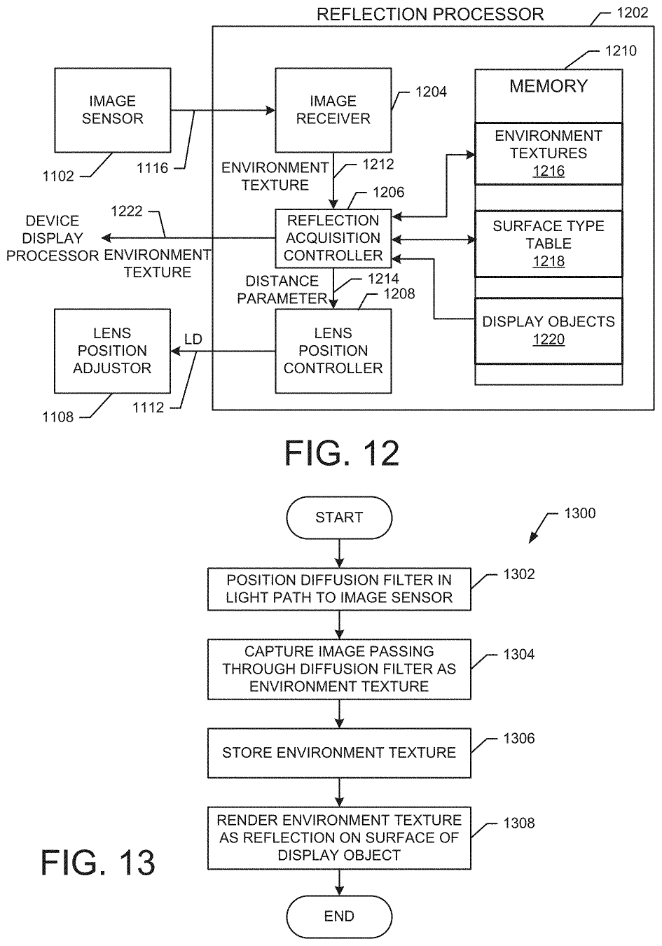

The amount that the incoming light rays are blurred or unfocused corresponds to a surface reflectivity of an object onto which surface reflections are to be rendered. Thus, if the surface of the object is highly reflective (e.g., mirror-like finish), then the adjustor 1108 adjusts the distance 1110 such that the captured environment texture is in-focus or nearly in-focus at the plane of the image sensor 1102. The captured environment texture then can be used to represent surface reflections on a rendered object having a mirror-like finish. However, if the surface of the object is not highly reflective (e.g., matte finish), then the adjustor 1108 adjusts the distance 1110 such that the captured environment texture is out-of-focus to a degree that corresponds to the surface reflectivity of the surface of the object. The captured environment texture then can be used to represent surface reflections on an object having a matte finish. The lens position adjustor 1108 is controlled by a reflection processor described with reference to FIG. 12.

FIG. 11B shows an exemplary embodiment of a fixed diffusion filter that provides a fixed distance between a lens and an image sensor. For example, the fixed diffusion filter comprises a lens 1122, image sensor 1128, and mounting apparatus 1120A/B that holds the lens 1122 at a fixed distance from the image sensor 1128.

During operation, incoming light rays 1124 pass through the lens 1122 and form a focused image 1126 at the focal distance 1132. Since the image sensor 1128 is located at a distance from the lens 1122 that is different form the focal distance 1132, a blurred and diffused image is captured by the image sensor 1128. The image sensor 1102 captures this blurred and diffused image and outputs this image as an environment texture 1130. In an exemplary embodiment, this blurred image is captured as an environment texture by the image sensor 1128 and used to represent surface reflections on a rendered object.

The amount that the incoming light rays are blurred or unfocused corresponds to a surface reflectivity of an object onto which surface reflections are to be rendered. Thus, if the surface of the object is highly reflective (e.g., mirror-like finish), then the fixed distance from the lens 1122 to the image sensor 1128 is fixed to be close to the focal length 1132 such that the captured environment texture is in-focus or nearly in-focus at the plane of the image sensor 1128. The captured environment texture then can be used to represent surface reflections on a rendered object having a mirror-like finish. However, if the surface of the object is not highly reflective (e.g., matte finish), then the fixed distance from the lens 1122 to the image sensor 1128 is fixed to be much larger or much smaller than the focal length 1132 such that the captured environment texture is blurred and out of focused at the plane of the image sensor 1128. The captured environment texture then can be used to represent surface reflections on an object having a matte finish.

FIG. 12 shows a detailed exemplary embodiment of a reflection processor (RP) 1202. For example, the RP 1202 is suitable for use as the RP 206 shown in FIG. 2. The RP 1202 comprises image receiver 1204, reflection acquisition controller (RAC) 1206, lens position controller 1208, and memory 1210.

In an exemplary embodiment, the image receiver 1204 receives captures images 1116 from the image sensor 1102 and passes these images 1212 to the RAC 1206.

In an exemplary embodiment, the lens position controller 1208 receives a distance parameter 1214 from the RAC 1206 and generates the LD control signal 1112 that is output to the lens position adjustor 1108. For example, the lens position controller 1208 generates the LD control signal 1112 to adjust the position of the lens 1100 to achieve a desired distance 1110 between the lens 1100 and the image sensor 1102.

The RAC 1206 determines a surface type parameter associated with a display object to be rendered. For example, display objects 1220 are stored in the memory 1210. Each display object in the memory includes information describing surface types associated with that display object. In an exemplary embodiment, the surface type parameter for each object indicates the surface reflectivity of a surface of the object onto which reflections are to be rendered. For example, the surface type may indicate the surface of the object has a mirror-like surface or a rough matte surface.

In an exemplary embodiment, a surface type table 1218 identifies distance parameters associated with each surface type. Thus, the surface type table 1218 can be cross-referenced with a surface type parameter associated with a selected display object 1220 to determine a distance parameter 1214 that is output to the lens position controller 1208.

During operation, the RAC 1206 determines a surface type parameter associated with an object onto which a reflection is to be rendered. For example, surface type parameters are stored with the display objects 1220 in the memory 1210. The RAC 1206 uses this surface type parameter to access the surface type table 1218 in the memory to obtain a distance parameter. The distance parameter 1214 is output to the lens position controller 1208 which uses this parameter to generate the LD control signal 1112. The lens position adjustor 1108 adjusts the position of the lens 1100 bases on the LD control signal 1112. This results in the incoming light rays 1114 being blurred or out of focus by a selected amount at the image sensor 1102.

The image sensor 1102 captures the blurred image and outputs the captured image data 1116 as an environment texture to the image receiver 1204. The image receiver 1204 passes the captured environment texture 1212 to the RAC 1206. The RAC 1206 optionally stores the environment texture in the memory 1210 as environment textures 1216.

The RAC 1206 outputs the environment texture over output 1222 to a device display processor. For example, the device display processor utilizes the environment texture to render reflections on selected objects in a rendered 3D scene.

Table 1 below shows and exemplary embodiment of the surface type table 1218. For each surface type, a distance parameter is provided that can be used by the lens distance adjustor 1108 to adjust the position of the lens 1100 to obtain the desired amount of image blurring or defocus. For example, surface type 0 may be associated with the most reflective surface and surface type 4 may be associated with the least reflective surface. It should be noted that Table 1 is exemplary and that other surface type and distance tables may be utilized.

TABLE 1

| Surface Type Parameter | Distance Parameter |
|---|---|
| 0 | 1.5 |
| 1 | 1.4 |
| 2 | 1.3 |
| 3 | 1.2 |
| 4 | 1.1 |

FIG. 13 shows an exemplary embodiment of a method 1300 for generating an environment texture using a diffusion filter. For example, the method 1300 is suitable for use with the diffusion filters shown in FIGS. 9-10.

At block 1302, a diffusion filter is positioned in a light path that leads to an image sensor. For example, as illustrated in FIGS. 9-10, the diffusion filter may have a coated or etched surface that scatters light rays passing through the filter. FIGS. 9-10 illustrate how the diffusion filter is positioned in the light path leading to the image sensor. For example, the diffusion filter 900 can be placed in front of the lens 902 or the diffusion filter 1000 can be placed between the lens 1002 and the image sensor 1004.

At block 1304, the image passing through the diffusion filter is captured by an image sensor. For example, as illustrated in FIGS. 9-10, the light rays passing through the diffusion filter 900 are captured by the image sensor 904, and the light rays passing through the diffusion filter 1000 are captured by the image sensor 1004. The captured images represent environment textures.

At block 1306, the environment texture is optionally stored in a memory.

At block 1308, the environment texture is output to a device display processor. For example, if the display object is a cup, the environment texture is rendered as a reflection on the surface of the cup. In various exemplary embodiment, the environment texture may be resized, rotated, compressed or otherwise processed before being rendered on the surface of the cup as a reflection.

Thus, the method 1300 operates to utilize a diffusion filter to capture environment textures for use as reflection data. It should be noted that although the method 1300 describes specific operations, these operations may be changed, modified, rearranged, added to, and subtracted from within the scope of the embodiments.

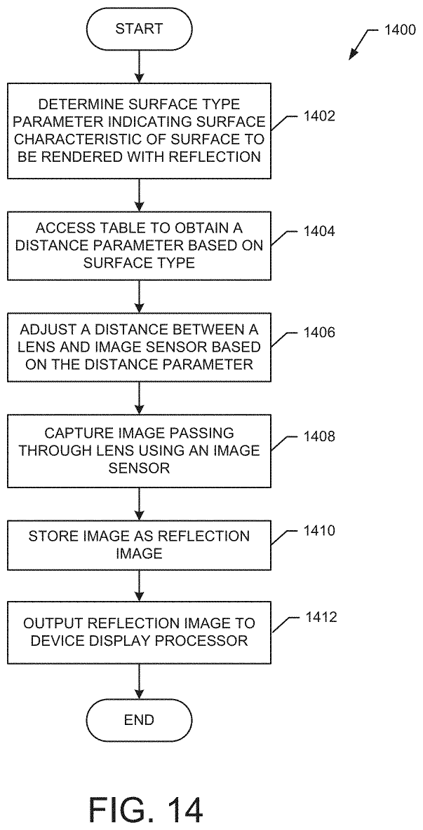

FIG. 14 shows an exemplary embodiment of a method 1400 for generating environment textures using an adjustable diffusion filter. For example, the method 1400 is suitable for use with the adjustable diffusion filter shown in FIG. 11 and the reflection processor shown in FIG. 12.

At block 1402, a surface type parameter is determined. The surface type parameter identifies a surface type of an object onto which a reflection of the environment is to be rendered. In an exemplary embodiment, the surface type parameter is determined from object data 1220 stored in the memory 1210. For example, the RAC 1206 retrieves the object data for the object to be rendered with the reflection and determines the surface type parameter from the object data associated with this object.

At block 1404, a table is accessed to determine a distance parameter associated with the received surface type parameter. For example, the RAC 1206 accesses the surface type table 1218 stored in the memory 1210 to determine a distance parameter associated with the received surface type parameter.

At block 1406, a distance between a lens and an image sensor is adjusted based on the distance parameter. For example, the lens position controller 1208 receives the distance parameter 1214 and generates a LD control signal 1112 that is input to the lens position adjustor 1108. Based on the received LD control signal 1112, the lens position adjustor 1108 moves the lens 1100 mounted to the sliding rails 1106 along the mounting apparatus 1104 to position the lens 1100 to a desired distance 1110 from the image sensor 1102.

At block 1408, the image passing through the lens is captured by an image sensor. For example, the image in the light rays 1114 passes through the lens 1100 and is blurred or defocused at the surface of the image sensor based on the distance of the lens to the image sensor. The image sensor 1102 captures the defocused image and outputs this image as environment texture 1116 to the image receiver 1204.

At block 1410, the environment texture is optionally stored in a memory. For example, the RAC 1206 receives the environment texture 1212 from the image receiver 1204 and stores this image in the memory.

At block 1412, the environment texture is output to a device display processor. For example, the display object has a surface with a surface type indicated by the received surface type parameter. The environment texture represents how environment reflections would appear on that type of surface. The device display processor operates to render the object with environment texture derived from the captured image. For example, the environment texture may be further processed by the display processor, such as by resizing, cropping, reducing, or otherwise adjusting the environment texture to appear as a reflection on the surface of the display object. Thus, the environment texture is efficiently captured and rendered while eliminating or reducing the amount of image calculations typically utilized.

Thus, the method 1400 operates to generate environment textures using an adjustable diffusion filter. It should be noted that although the method 1400 describes specific operations, these operations may be changed, modified, rearranged, added to, and subtracted from within the scope of the embodiments.

### Summary

In a real-time 3D environment projection system, the step of computing a convolution is an expensive operation. First, some convolution algorithms are exceedingly expensive, occurring in exponential time. Second, even for very efficient algorithms, convolving images at frame rates common for video (30-60 frames per second) represents a significant computational burden placed on the system. The cost of such computation may be mitigated by instead convolving the incoming light in the optical path. This may be done in one of three ways as illustrated in the various exemplary embodiments provided herein.

1. Apply a permanent, fixed diffusion filter to the lens.
2. Configure the lens such that it is mechanically fixed in a defocused position.
3. Configure a mechanically actuated (auto-focus) lens such that it is adjustably defocused.

### Fixed Diffusion Filter

As illustrated in FIG. 6 and FIG. 8, a permanent, fixed diffusion filter is applied to an otherwise ordinary optical lens. The filter may be comprised of any material, mechanically or chemically affixed to the lens, which results in a degree of diffusion of incoming light. Alternatively, the lens glass may be etched to produce the desired effect. As such, light rays are scattered as they pass through the lens and diffusion filter element, causing the captured image to be blurred.

An advantage of such a permanent installation is to convey to the end-user that an image sensor so equipped is not surveilling them while they use the device. Insofar as surveillance is problematic for the end-user, the fact that an image sensor may be active while the device is in use, may represent a problem. However, since a lens equipped with a convolution filter cannot discern details of the user or their surroundings, and that the installation of the filter is visibly apparent, such concern is mitigated.

An additional benefit of such a configuration is that the image sensor is dedicated to the purpose of acquiring diffuse environment images. It does not also have to serve as a high-resolution imaging device for use cases such as photography or video chat. As such, a cheaper, less sophisticated image sensor may be selected to serve this purpose.

In such an installation, the image sensor may be dedicated for this particular purpose. Insofar as the system designer also desires a system capable of photography or other camera-enabled use-cases, it is possible to install an additional sensor, thereby increasing cost and system complexity.

In such an installation, the degree of convolution of the environment image is fixed. Due to this, the degree to which reflectivity of an object may be configured is limited. Typically, to implement configurable reflectivity, a series of convolutions—each blurring the environment image to a different degree—is generated, and subsequently combined to create a particular degree of blur. A way to work around this is to install multiple image sensors, each with a lens that convolves incoming light to a different degree.

In an exemplary embodiment, a separate optical element with a diffuse surface coating is mounted in front of an ordinary camera lens, forming a camera lens assembly.

In an exemplary embodiment, a separate optical element with a diffuse surface coating is mounted behind an ordinary camera lens, forming a camera lens assembly.

In an exemplary embodiment, an otherwise ordinary camera lens is coated with a coating that acts as an optical diffusion element.

In an exemplary embodiment, an otherwise ordinary camera lens is etched (e.g. chemically etched) to form a rough surface which acts to diffuse incoming light rays.

### Fixed Defocused Lens

In alternative embodiments, as illustrated in FIG. 11B, a lens is installed in a permanently defocused position. The lens position relative to the focal plane—and therefore the degree of blur—is fixed. Multiple degrees of blur may be achieved by installing additional image sensors, each configured to a differing degree of blur.

Such an installation would be simpler than installation of a diffusion filter, due to there being fewer components per image sensor. However, it would not offer the user the assurance of being free of surveillance, and it would limit the degree to which reflectivity may be configured.

In an exemplary embodiment, the camera lens of an image sensor is mounted in a fixed, defocused position.

In an exemplary embodiment, a series of image sensors, each with a camera lens mounted in a fixed, defocused position are installed in a smartphone. Each image sensor represents a particular degree of convolution, thereby enabling runtime approximation of intermediate degrees of convolution.

### Defocus Via Auto-Focus

In alternative embodiments, as illustrated in FIG. 11A, an auto-focusing lens is used, which is adjustably defocused to the desired degree of convolution. As such, an autofocus mechanism would enable a single camera to capture environment images of varying degrees of convolution.

One advantage of such an implementation is that the image sensor may serve multiple purposes. It may serve as both the environment camera in service of environmentally lit rendering, and also as a camera in service of photography, video chat, or similar. As such, component count is reduced, thereby reducing system cost and complexity.

In an exemplary embodiment, an auto-focusing image sensor is mounted in a smartphone. In order to capture a convolved environment texture, the image sensor is configured to defocus the camera lens, and the image is captured. This can be done repeatedly for varying degrees of convolution, by defocusing the image sensor corresponding to the desired degree of convolution. It can also be done rapidly; many times per second.

While particular embodiments of the present invention have been shown and described, it will be obvious to those skilled in the art that, based upon the teachings herein, changes and modifications may be made without departing from these exemplary embodiments of the present invention and its broader aspects. Therefore, the appended claims are intended to encompass within their scope all such changes and modifications as are within the true spirit and scope of these exemplary embodiments of the present invention.

What is claimed is:

1. An apparatus, comprising:
a diffusion filter that diffuses light from an environment to generate diffused light, wherein an amount of diffusion provided by the diffusion filter corresponds to a surface characteristic of a surface of an object to be rendered on a display; and
an image sensor that captures the diffused light as an environment texture for rendering as a reflection of the environment on the surface of the object.

2. The apparatus of claim 1, further comprising a lens located between the diffusion filter and the image sensor, wherein the diffused light passes through the lens before striking the image sensor.

3. The apparatus of claim 1, further comprising a lens located in front of the diffusion filter, wherein the light from the environment passes through the lens before striking the diffusion filter.

4. The apparatus of claim 1, wherein the diffusion filter comprises a diffusion lens having a diffusion coating affixed to a lens.

5. The apparatus of claim 1, wherein the diffusion filter comprises a lens having a diffusion surface.

6. The apparatus of claim 1, wherein the surface characteristic corresponds to a surface reflectivity of the surface of the object.

7. The apparatus of claim 6, wherein the surface reflectivity is selected from a range comprising mirror-like completely reflective to matte-like completely non-reflective.

8. The apparatus of claim 6, wherein the diffusion filter comprises a lens that defocuses the light from the environment to generate the diffused light on a surface of the image sensor, wherein an amount of defocus corresponds to the surface reflectivity of the surface of the object to be rendered on the display.

9. An apparatus, comprising:
a lens that passes light representing an image of an environment;
an image sensor that captures the light as an environment texture to be rendered on a surface of an object as a reflection of the environment; and
a controller that adjusts a distance between the lens and the image sensor to defocus the light at the image sensor, wherein an amount of defocus corresponds to the surface characteristic of the surface of the object.

10. The apparatus of claim 9, further comprising:
a moveable fixture attached to the optical lens; and
an adjustor that moves the movable fixture in response to a control signal to adjust the distance between the optical lens and the image sensor.

11. The apparatus of claim 10, further comprising a lens controller that receives a distance parameter from the controller and outputs the control signal.

12. The apparatus of claim 9, further comprising a memory that stores a table that identifies surface types and corresponding distances.

13. The apparatus of claim 12, wherein the controller accesses the memory to determine a selected surface type associated with a selected object and to determine a selected distance associated with the selected surface type.

14. The apparatus of claim 9, wherein the controller outputs the environment texture for rendering as an environment reflection on the surface of the object.

15. A method, comprising:
determining a surface type of a surface of a display object to be rendered on a display;
determining a distance associated with the surface type;
adjusting at least one of a lens and an image sensor so that they are separated by the distance associated with the surface type; and
capturing an environment texture from light rays that pass through the lens and strike the image sensor.

16. The method of claim 15, further comprising rendering the display object on the display with the environment texture rendered as a reflection on the surface of the display object.

17. The method of claim 15, further comprising:
maintaining a table of surface types and corresponding distances; and
accessing the table with the surface type to determine the distance.

18. The method of claim 15, wherein the operation of adjusting comprises controlling a moveable fixture to move the lens so that the lens and the image sensor are separated by the distance.

19. The method of claim 15, wherein the environment texture is an image of an environment around a device.

20. The method of claim 15, wherein the surface type identifies a surface reflectivity that ranges from a mirror-like completely reflective reflectivity to a matte-like completely non-reflective reflectivity.
